(19) United States
(12) Patent Application Publication
(10) Pub. No.: US 2006/0001191 A1
(43) Pub. Date: Jan. 5, 2006

(54) Shroud assembly and a method of fabrication thereof

(75) Inventors: Philippe Cusson, Saint-Nicolas (CA); Dany Boivin, Buckland (CA)

Correspondence Address: AKERMAN SENTERFITT, P.O. BOX 3188, WEST PALM BEACH, FL, 33402-3188, US

(73) Assignee: IPL Inc., St-Damien-de-Bellechasse (CA)

(21) Appl. No.: 11/156,420

(22) Filed: Jun. 20, 2005

Related U.S. Application Data
(60) Provisional application No. 60/580,702, filed on Jun. 21, 2004.

(51) Int. Cl. B29C 45/16

(52) U.S. Cl. 264/255

(57) ABSTRACT

There is provided a shroud assembly and a method of fabrication thereof, wherein at least one boot is molded in a resilient thermoplastic material on a shroud part molded in a rigid thermoplastic material to form an integral assembly.

### CROSS REFERENCE TO RELATED APPLICATIONS

This application claims priority on U.S. provisional application No. 60/580,702, filed on Jun. 21, 2004 which is incorporated herein by reference.

### FIELD OF THE INVENTION

The present invention relates to shrouds. More specifically, the present invention is concerned with a shroud assembly and a method of fabrication thereof.

### BACKGROUND OF THE INVENTION

Efforts have been made in the industry for developing new methods of fabricating shrouds for surrounding ends of shafts.

In the case shrouds for steering column, for example, it is known to assemble parts thereof, typically made in polypropylene (PP), which accommodate openings necessary for the passage of a number of members including transmission levers, blinker actuators, tilt steering etc, prior to protecting these openings with boots made during an additional step typically in a thermoplastic elastomer (TPE), or, in the case of a boot of a transmission lever, by snapping a multi-material TPE piece on the shroud (see for instance U.S. Pat. No. 6,578,449 to Anspaugh et al.).

The boot for the transmission lever is one of the larger boots, as well as one that is highly solicited by a driver during operation of the transmission lever along several axes. Furthermore, an aesthetic aspect thereof has increasingly become a parameter of concern.

There seems to be still room in the art for a shroud assembly and a method of fabrication thereof.

### SUMMARY OF THE INVENTION

There is provided a shroud assembly, comprising a body to be mounted around a shaft and at least one member integrated in an opening of the body, the body being molded in a rigid thermoplastic material; the at least one member is overmolded in a resilient thermoplastic material on the body to form an integral assembly in a single multi-material injection molding machine.

There is provided a method for fabricating a shroud assembly in a single multi-material injection molding machine having a first cavity for injecting a rigid thermoplastic material, a second cavity for injecting a resilient thermoplastic material, a first and a second cores coupled successively to the first cavity and the second cavity, the shroud assembly having at least one resilient boot integrated on a rigid shroud body. The method comprises the steps of: injecting the rigid thermoplastic material in the first cavity coupled with the first core, preserving regions to be molded in the resilient thermoplastic in the second cavity in a second injection cycle; injecting the resilient thermoplastic material in the second cavity coupled with the second core, in a first injection cycle; injecting the resilient thermoplastic material in the first core coupled with the second cavity; injecting the rigid thermoplastic material in the second core coupled with the first cavity, in the second injection cycle; repeating the first and second injection cycles; demolding; and yielding a resilient boot overmoulded on a rigid shroud part.

There is provided a method for fabricating a shroud assembly, comprising at least one resilient member integrated on a rigid body, in a single multi-material injection molding machine having first and a second cores A and B, first and a second cavities C and D, the first cavity C comprising masking shapes for preserving regions to be molded in a resilient thermoplastic in the second cavity D, comprising the steps of: molding the rigid body in a rigid thermoplastic material in the first cavity C; and overmolding the at least one resilient member in a resilient thermoplastic material in the second cavity D; whereby the steps of molding the rigid body and of overmolding the at least one resilient member are performed during successive molding cycles, the first and second.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a first exploded view of a shroud assembly according to an embodiment of the present invention;

FIG. 2 is a second exploded view of the shroud assembly of FIG. 1; and

FIG. 3 is a perspective view of the shroud assembly of FIGS. 1 and 2.

### DESCRIPTION OF EMBODIMENTS OF THE INVENTION

There is provided a shroud assembly and a method of fabrication thereof, wherein at least one boot is molded in a resilient thermoplastic material on a shroud part molded in a rigid thermoplastic material to form an integral assembly.

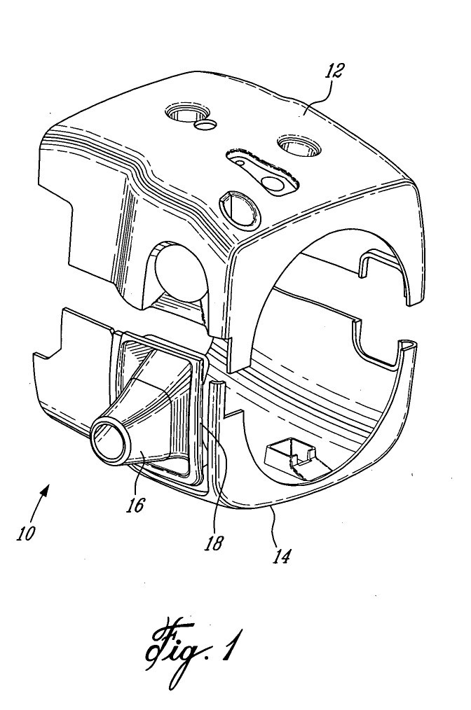

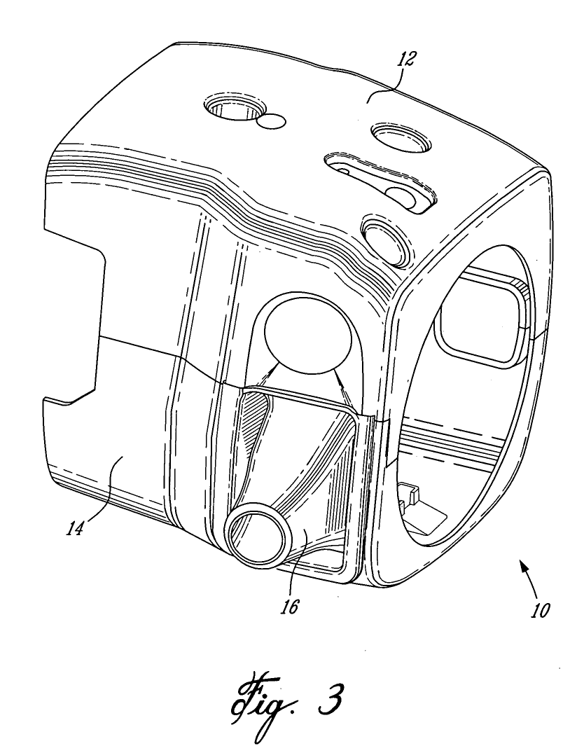

As illustrated in FIGS. 1-3 of the appended drawings, a shroud assembly 10 comprises a body including a first shroud part 12 and a second shroud part 14. In the embodiment Illustrated, the second shroud part 14 comprises an opening and a boot 16 integrated in a region of the opening.

The shroud parts 12, 14 may be intended to be mounted around a shaft such as a vehicle steering column, and the opening intended for connection of the steering column. The boot 16 typically comprises a protective bellow to cope with misalignments that may occur between the steering column and the opening.

The shroud parts 12 and 14 and the boots are molded, and the boot 16 is integrated in the shroud part 14 without any assembling step, using by a single multi-material injection molding machine.

A four-cavity multi-material injection-molding machine is used, comprising cores A and B respectively, and cavities C and D.

According to the present invention, the cavity C comprises masking shapes allowing molding rigid thermoplastic parts while preserving regions to be molded in the cavity D, which is used for molding parts made in a resilient thermoplastic material.

The injection molding machine may comprise a floating platen and a stationary platen, the cores A and B being located on the floating platen while the cavities C and D are located on the stationary platen. Therefore, the cores A and B are mobile and face the cavities C and D at times of an injection cycle on the floating platen of the injection molding machine, the cavities C and D being fixed. The multi-material injection molding machine thus provides that the cores A and B couple with the cavity C or D successively depending on the injection cycle of the injection molding machine.

Alternatively, in the case of an injection-molding machine without floating platen, a robot arm may be used for example, to move the workpiece piece from the first core to the second core and reverse for example.

An injection machine with a mobile part that rotates along a horizontal axis has also been found to be effective.

The method generally comprises molding rigid parts of a shroud and over-molding at least one resilient thermoplastic material part over at least one the rigid parts.

More precisely, during a first injection cycle, a rigid thermoplastic material is injected in a first assembly including a first core A and a first cavity C of a injection molding machine as described hereinabove, and a resilient thermoplastic material is injected in a second assembly including the second core B and the second cavity D. In a following injection cycle, the resilient thermoplastic material is injected in a third assembly including the first core A and the second cavity D and the rigid thermoplastic material is injected in a fourth assembly including the second core B and the first cavity C; and so on during successive injection cycles, the injection molding machine being provided with a rotation cycle mechanism allowing that the cores and cavities be paired in a cycle in relation to the workpiece, as described hereinabove.

The resulting workpiece comprises rigid parts with at least one integrated resilient part.

The rigid thermoplastic material may be polypropylene (PP) and the resilient thermoplastic material may be a thermoplastic elastomer may be a (TPE).

It is found that a number of geometrical features of the rigid part and of the cores and cavities need adjusting to allow the multi-material injection described hereinabove.

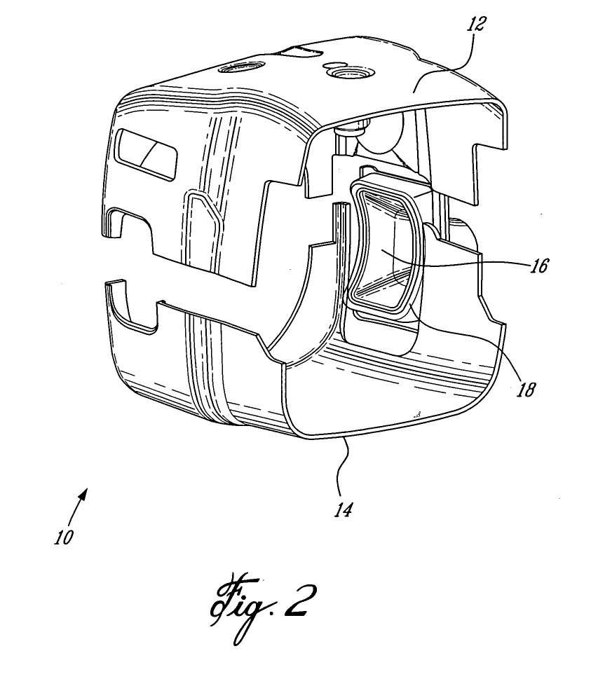

First, it is found that the coupling with the cavity of injection of the resilient thermoplastic material (cavity D in the example above) needs to be achieved in such a way as to prevent spilling of the resilient thermoplastic during injection thereof, in order to prevent resilient thermoplastic flashes around regions to be molded over the already molded rigid part. Such tight, sealed off coupling is achieved through predetermined measurements and angles (comprised between 5 and 10 degrees for example) of surfaces of the rigid parts to be molded (in the regions labeled 18 of FIGS. 1 and 2 for example). Moreover, a molding allowance is determined around the parts to be molded in the resilient material to allows an improved coupling between the already molded rigid part and the cavity of injection of the resilient thermoplastic material (cavity D in the example above) when the resilient material is injected to allow, under pressure, a mechanical interference in the rigid material.

Second, injection locations of the resilient thermoplastic may be selected to favor ejecting air during injection. For example, when molding a transmission boot as illustrated in FIGS. 1 to 3, it is found that injection may be initiated at the bottom of the boot or through a channel on the surface of the already molded rigid part. Moreover, an air channel may be provided on an end of the drive selector lever to allow air evacuation during injection of the boot, thereby preventing air to be trapped, which would result in damaging the molded surface of the molded workpiece.

Third, demolding of the resulting molded workpiece is to be considered carefully, taking into account that the integrated resilient parts may protrude from the rigid parts, as in the case of the shroud assembly for a transmission boot as described hereinabove. A procedure such as the one known as Flip Frame may be used. One must ensure that the demolding angle is sufficient and that adequate devices (such as sliders and lifters) are used for the removal of the molded piece.

Although the present invention has been described hereinabove by way of embodiments thereof, it may be modified, without departing from the nature and teachings of the subject invention as described herein.

What is claimed is:

1. A shroud assembly, comprising:
a body to be mounted around a shaft; and
at least one member integrated in an opening of said body, said body being molded in a rigid thermoplastic material;
wherein said at least one member is overmolded in a resilient thermoplastic material on said body, to form an integral assembly, in a single multi-material injection molding machine.

2. The shroud assembly according to claim 1, wherein said body is molded in Polypropylene (PP) and said at least one member is overmoulded in a thermoplastic elastomer may be a (TPE).

3. The shroud assembly according to claim 1, wherein said body is molded and said at least one member is overmolded by injection of the rigid thermoplastic material and of the resilient thermoplastic material respectively in a first and in a second cavity of the multi-material injection molding machine during successive injection cycles, the cavities being successively paired to successive one of two cores of the multi-material injection molding machine.

4. The shroud assembly according to claim 1, wherein said body is a rigid part of a shroud molded and said at least one member is at least one boot.

5. A method for fabricating a shroud assembly in a single multi-material injection molding machine having a first cavity for injecting a rigid thermoplastic material, a second cavity for injecting a resilient thermoplastic material, a first and a second cores coupled successively to the first cavity and the second cavity, the shroud assembly comprising at least one resilient boot integrated on a rigid shroud body, comprising the step of:
injecting the rigid thermoplastic material in the first cavity coupled with the first core, preserving regions to be molded in the resilient thermoplastic in the second cavity in a second injection cycle; and injecting the resilient thermoplastic material in the second cavity coupled with the second core, in a first injection cycle;
injecting the resilient thermoplastic material in the first core coupled with the second cavity; and injecting the rigid thermoplastic material in the second core coupled with the first cavity, in the second injection cycle;
repeating said first and second injection cycles; and
demolding;
yielding a resilient boot overmoulded on a rigid shroud part.

6. A method for fabricating a shroud assembly, comprising at least one resilient member integrated on a rigid body, in a single multi-material injection molding machine having first and a second cores A and B, first and a second cavities C and D, the first cavity C comprising masking shapes for preserving regions to be molded in a resilient thermoplastic in the second cavity D, comprising the step of:
molding the rigid body in a rigid thermoplastic material in the first cavity C; and
overmolding the at least one resilient member in a resilient thermoplastic material in the second cavity D;
whereby said steps of molding the rigid body and of overmolding the at least one resilient member are performed during successive molding cycles, the first and second cavities C and D being coupled successively with the first and second.

7. The method according to claim 5, wherein coupling of one of the first and second cores with the second cavity D is adjusted according to dimensions and angles of surfaces of the rigid parts of the workpiece.

8. The method according to claim 6, wherein a molding allowance is determined around the at least one resilient member to be molded in the resilient thermoplastic material to allows an improved coupling between the already molded rigid body and the second cavity D when the resilient thermoplastic material is injected.

9. The method according to claim 6, wherein said step of molding the rigid body comprises injecting polypropylene (PP), and said step of overmolding the at least one resilient member comprises injecting a thermoplastic elastomer (TPE).

10. The method according to claim 6, wherein the multi-material injection molding machine comprises a rotation cycle mechanism allowing that the cores and cavities be paired in a cycle.

11. The method according to claim 6, wherein the injection molding machine comprises a floating platen and a stationary platen, the cores A and B being located on the floating platen and the cavities C and D being located on the stationary platen.

12. The method according to claim 6, wherein a robot arm is used to select one of the first core and the second core and reverse according to the injection cycle.

13. The method according to claim 6, wherein the injection molding machine comprises a mobile part that rotates along a horizontal axis to successively couple the first and second cavities C and D with the first and second cores A and B.
